(19) United States
(12) Patent Application Publication
(10) Pub. No.: US 2013/0009879 A1
(43) Pub. Date: Jan. 10, 2013

(54) LAYOUT FOR LETTERS OF THE ENGLISH ALPHABET ON THE KEYPAD OF A MOBILE PHONE

(76) Inventor: Hyung chong Baik, Seoul (KR)

(21) Appl. No.: 13/637,016

(22) PCT Filed: May 14, 2010
(86) PCT No.: PCT/KR2010/003051

§ 371 Date: Sep. 24, 2012

(30) Foreign Application Priority Data
Mar. 24, 2010 (KR) 10-2010-0026027

(51) Int. Cl. G06F 3/02

(52) U.S. Cl. 345/169

(57) ABSTRACT

The present invention relates to a layout for letters of the English alphabet on the keypad of a mobile phone; and more specifically, to a new layout for letters of the English alphabet on the keypad of a mobile phone, by means of which it is easy to recognize and use the letters in the English alphabet compared to the traditional layout therefor and texting efficiency is substantially improved. To this end, the present invention provides a layout for the mobile phone keypad in English, featuring easy visual recognition and substantially improved texting efficiency. In the layout, the letters of the English to alphabet are arranged on 10 number buttons according to the basic letter composition and the alphabetic serial order as memorized by people, the vowels A, E, I, O and U being used more frequently as relative to the composition ratio thereof are placed as the first letters in the corresponding groups of letters, respectively, shown on each number button, and those vowels is are diagonally and equally arranged on the 1, 3, 5, 7 and 9 number buttons. This structure provides uniform regularity to the alphabet letters and to the vowel groups on the keypad.

### TECHNICAL FIELD

The present invention relates to a layout for letters of the English alphabet on the keypad of a mobile phone, and in particular to a layout for letters of the English alphabet on the key pad of a mobile phone which makes it possible to more easily recognize and use the English vowels and consonants as compared to the conventional English alphabet consonants and vowels, thus obtaining an efficient sentence wording.

### BACKGROUND ART

Many English alphabet consonant and vowel layouts which make it possible to obtain an easier recognition and use and an efficient sentence is wording as compared to a conventional English alphabet consonant and vowel layout for a mobile phone are widely used; however such conventional English alphabet consonant and vowel layouts have many problems.

First of all, the layouts of them are not easy to recognize or use because the layouts were configured without considering a constant consistency that an English alphabet consonant and vowel has, and the usability of consonants and vowels.

Second of all, the consonants and vowels used in a vocabulary construction are arranged at an intermediate portion or at an end portion of a consonant and vowel group which is arranged at one numeral pad, which results in increasing the number of key strokes, so the efficiency of sentence wording becomes very bad.

### DISCLOSURE OF INVENTION

Accordingly, it is an object of the present invention to provide a layout for letters of the English alphabet on the keypad of a mobile phone which makes it possible to more easily recognize and use the English vowels and consonants as compared to a conventional English alphabet consonant and vowel layout, thus obtaining an efficient sentence wording.

To achieve the above objects in a method for dividing the consonants and vowels into two parts and arranging them on 10 number keys and assigning the consonant and vowel construction of 5 vowel row and vowel paragraphs which are separated about 5 vowels of A, E, I, O and U using a certain rule that the English alphabet consonant and vowel system has in a sequence that a basic construction arrangement consonant and vowel arrangement with respect to English alphabet consonants and vowels in a keypad of a cellular phone and an sequence formed by memorizing it, there is provided a layout for letters of English alphabets on a keypad of a mobile phone, which comprises alphabets A and B which are assigned to a number key of 1; alphabets C and D which are assigned to a number key of 2; alphabets E and F which are assigned to a number key of 3; alphabets G and H which are assigned to a number key of 4; alphabets I, J and K which are assigned to a number key of 5; alphabets L, M and N which are assigned to a number key of 6; alphabets O, P and Q which are assigned to a number key of 7; alphabets R, S and T which are assigned to a number key of 8; alphabets U, V and W which are assigned to a number key of 9; and alphabets X, Y and Z which are assigned to a number key of 10, the vowels A, E, I, O and U which are more frequently used than the consonants of a vocabulary construction are assigned as the first consonant and vowel of the consonant and vowel group arranged on one keypad, thus significantly reducing the key strokes, and the vowels A, E, I, O, U are assigned in diagonal directions in such a way that the vowel of A is assigned to the key of 1, and the vowel of E is assigned to the key of 3, and the vowel of I is assigned to the key of 5, and the vowel of O is assigned to the key of 7, and the vowel of U is assigned to the key of 9, thus obtaining a certain regularity in terms of the alphabet consonants and vowels as well as a vowel system in the keypad, and the sentence symbols “,” and “.” which are generally used for a quick writing of sentence and the sentence function keys “ [symbol] ” and “ [symbol] ” are assigned to the symbols of “*” and “#”, and 10 number keys and 2 function keys are separated from one another and are balanced in the layout, so the visual recognition of the keypad and the use of it are easy, and the writing of the sentences can be significantly enhanced.

### ADVANTAGEOUS EFFECTS

The effects of a new layout for the English alphabet consonants and vowels on the key pad of a mobile of the present invention will be described. First, a recognition and memory are easy because an alphabet consonant and to vowel layout and its memorization match in a sequence that a user has memorized. Second, a recognition and memorization are easy because an alphabet consonant and vowel layout has a constant rule that a balance and a combination are well organized about the vowels. Third, the group consisting of the frequently used consonants and vowels is assigned as a first consonant and is vowel of the consonant and vowel group arranged in one number as compared to the construction ratio. The key strokes significantly decrease, so the sentence wording is faster, which results a quick and efficient work as compared to the conventional keypad.

### BRIEF DESCRIPTION OF DRAWINGS

FIG. 1 is a view illustrating an English consonant and vowel arrangement on a keypad for a mobile phone.

### MODES FOR CARRYING OUT THE INVENTION

Arrangement Conditions:

The arrangement conditions are organized for the purpose of effectively utilizing the function keys which make it possible to express the English alphabet consonants and vowels and the symbols in the sentences and the vocabulary and the rows of the sentences which are to necessarily needed when organizing the sentences for an English text communication by using 12 keys formed of 10 telephone numbers and two function keys which are used for the sake of a cellular voice communication.

First of all, the alphabet consonants and vowels consist of 26 letters which are assigned to a key pad formed of fewer keys than them for an efficient is arrangement.

Second of all, the sentence symbols are a comma used to separate the unit paragraph, and a period used for completing the unit sentence, and as the function keys, there are a symbol “ [symbol] ” which corresponds to the function of a space bar used to separate vocabulary, and a symbol “ [symbol] ” which corresponds to the Enter function used to start a new paragraph of the sentence. The above mentioned symbols should be arranged for the purpose of an easier recognition and an easier use, and an efficient arrangement of the writing of sentences is needed.

Analysis of Language:

The reviews on the English alphabet consonants and vowels arranged on the keypad will be described.

1. The English alphabet consonant and vowel system is formed of 26 letters: the vowels consisting of 5 letters and the consonants consisting of 21 consonants, and the basic consonant and vowel constructions are as follows.

=A,B,C,D,E,F,G,H,I,J,K.L,M,N,O,P,Q,R,S,T,U,V,W,X,Y,Z,=

2. It is hard to memorize at a time 26 letters when learning the consonants and vowels, so the paragraphs are needed. The learner is trying to learn them in such as a way that the alphabet consonants and vowels are divided into 7 syllables and 4 scales depending on the phonemes (audibly).

3. The alphabet consonant and vowel system has a constant rule which is helps easily learn and use as the alphabets and helps easily recognize visually for the sake of a proper arrangement on the keypad. The arrangement is configured to form a paragraph consisting of a vowel row and a consonant group about the vowels A, E, I, O, U.

The vowels A, E, I, O, U can be arranged with the first consonant and vowel being in the form of the paragraph consisting of the vowel row and consonant group.

=A,B,C,D,= =E,F,G,H,= =I,J,K,L,M,N,= =O,P,Q,R,S,T,= =U,V,W,X,Y,Z,=

4. The English sentence is formed in a combination of vowels and consonant in the construction of vocabulary. The vowels are more frequently used as compared in the consonant construction ratio. With a difficulty in the arrangements of the consonants and vowels in the local alphabets, the English alphabet consonants and vowels are recited, so a lot of affects are caused to the use of the alphabet consonants and vowels of a nation where a vowel use ratio is higher.

Principle of Arrangement

The arrangements of the consonants and vowels are organized using the principle of the vowel row paragraph about the vowels. The arrangement of the sentence symbols and the function keys are configured for each element not to is duplicate when in use.

The present invention will be described in details with reference to the accompanying drawings.

Method for Arranging Consonants and Vowels

According to the alphabet consonant and vowel arrangement rule, the consonants and vowels of 5 paragraphs consisting of the vowel rows and consonant groups are divided into two parts, and two A, E vowel rows are generated for each, and three I, O, U vowel rows are generated for each, so the total 10 paragraphs are assigned, two of which are arranged for each vowel row.

Row A: A,B/C,D

Row E: E,F/I G,H

Row I: I,J,K/L,M,N

Row O: O,P,Q/R,S,T

Row U: U,V,W/X,Y,Z

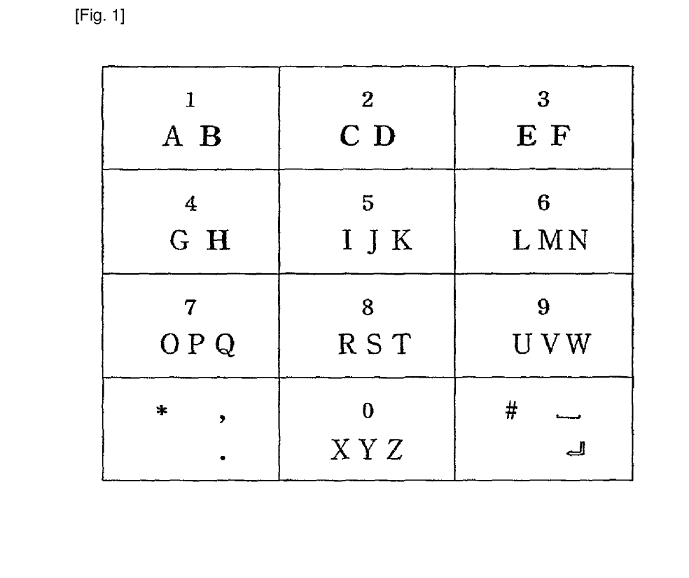

As shown in FIG. 1, the consonants and vowels of 5 paragraphs consisting of vowel rows and consonant groups are divided into two parts, and they are arranged on 10 keypads as follows.

A, B are exclusively assigned to the number 1

C, D are exclusively assigned to the number 2

E, F are exclusively assigned to the number 3

G, H are exclusively assigned to the number 4

I, J, K are exclusively assigned to the number 5

L, M, N are exclusively assigned to the number 6

O, P, Q are exclusively assigned to the number 7

R, S, T are exclusively assigned to the number 8

U, V, W are exclusively assigned to the number 9

X, Y, Z are exclusively assigned to the number 10

Arrangements of Sentence Symbols and Function Keys

The alphabet consonants and vowels are assigned to 10 numbers, and the symbol symbols and the sentence function keys are assigned to two * and # function keys in the priority sequence depending on the frequency of use as follows.

The comma “,” used for the separation of the unit paragraph of the sentence symbols and the period “.” used for the completion of the unit sentence are grouped as one, and the comma “,” is first assigned to the function keypad of “*” in the upper side of the keypad, and the period “.” is assigned to the lower side of it.

The symbol “ [symbol] ” used for the spacing of the vocabulary of the function keys and the symbol “ [symbol] ” used for starting a new paragraph are grouped and assigned to one key, and the symbol “ [symbol] ” is arranged at the upper side in the function keypad of the symbol “#” for the first use, and the symbol “ [symbol] ” is arranged at the lower side of the keypad.

Configuration of Arrangements

The alphabet consonants and vowels are assigned to 10 keypads to form a basic construction, and they are arranged in a sequence that they are memorized in the head, and the consonants and vowels of 5 groups consisting of vowel rows and constants and vowels classified about 5 vowels of A, E, I, O, U are grouped into two parts and are assigned to 10 keypads, so the vowels A, E, I, O, U which are more frequently used as compared to the construction ratio are arranged as the first consonant and vowel of the consonant and vowel group arranged on one keypad, thus reducing the number of strokes, and the vowels A, E, I, O, U are equally assigned to the keypad 1 in diagonal directions in such a way that A is assigned to 1, and E is assigned to 3, and I is assigned to 5, and O is assigned to 7, and U is assigned to 9, thus obtaining a constant is regularity in the alphabet consonants and vowels, and the keypad has a certain regularity in the vowel paragraph, which a visual recognition is enhanced, and the efficiency in writing the sentences is significantly enhanced. The sentence symbols “,” and “.” the sentence function keys “ [symbol] ” and “ [symbol] ” which are needed for a quick writing of sentences are properly arranged, and 10 number keys and 2 function keys are separated from one another, and the function keys except for the letters are balanced, which construction brings in an easier recognition of the keypad, and the use of it is easy.

1. A layout for letters of English alphabets on a keypad of a mobile phone, comprising:
alphabets A and B which are assigned to a number key of 1;
alphabets C and D which are assigned to a number key of 2;
alphabets E and F which are assigned to a number key of 3;
alphabets G and H which are assigned to a number key of 4;
alphabets I, J and K which are assigned to a number key of 5;
alphabets L, M and N which are assigned to a number key of 6;
alphabets o, P and Q which are assigned to a number key of 7;
alphabets R, S and T which are assigned to a number key of 8;
alphabets U, V and W which are assigned to a number key of 9; and
alphabets X, Y and Z which are assigned to a number key of 10,
the vowels A, E, I, o and U which are more frequently used than the is consonants of a vocabulary construction are assigned as the first consonant and vowel of the consonant and vowel group arranged on one keypad, thus significantly reducing the key strokes, and the vowels A, E, I, O, U are assigned in diagonal directions in such a way that the vowel of A is assigned to the key of 1, and the vowel of E is assigned to the key of 3, and the vowel of I is assigned to the key of 5, and the vowel of O is assigned to the key of 7, and the vowel of U is assigned to the key of 9, thus obtaining a certain regularity in terms of the alphabet consonants and vowels as well as a vowel system in the keypad, and the sentence symbols “,” and “.” which are generally used for a quick writing of sentence and the sentence function keys “ [symbol] ” and “ [symbol] ” are assigned to the symbols of “*” and “#”, and 10 number keys and 2 function keys are separated from one another and are balanced in the layout, so the visual recognition of the keypad and the use of it are easy, and the writing of the sentences can be significantly enhanced.
